(19) United States
(12) Patent Application Publication
(10) Pub. No.: US 2012/0303836 A1
(43) Pub. Date: Nov. 29, 2012

(54) SLAVE ID CONFIGURATION

(75) Inventors: Christopher T. Ngo, Queen Creek, AZ (US); Alexander W. Hietala, Phoenix, AZ (US)

(73) Assignee: RF MICRO DEVICES, INC., Greensboro, NC (US)

(21) Appl. No.: 13/478,254

(22) Filed: May 23, 2012

Related U.S. Application Data
(60) Provisional application No. 61/489,025, filed on May 23, 2011.

(51) Int. Cl. G06F 3/00

(52) U.S. Cl. 710/10

(57) ABSTRACT

Disclosed is a method in which slaves are cascaded on a bus, and cascading slave-to-slave communication is used to prioritize (or sequence) the software slave ID programming, enabling users to uniquely identify identical components in a circuit. In one embodiment, the first slave in the cascade stalls the programming of other slaves until the first slave's programming is complete. Once completed, the first slave then enables programming of the second slave, and so on. This embodiment allows multiple placements of identical slaves on the bus, and provides a method to uniquely identify and control each slave by using cascading software slave ID programming. In another embodiment, a structure with a similar effect may be created by lack of enablement (instead of disablement), wherein initially only the first slave is enabled, and subsequent slaves are not initially enabled. Additionally, the present disclosure is compatible with the MIPI RFFE standard interface.

### RELATED APPLICATIONS

This application claims the benefit of provisional patent application Ser. No. 61/489,025, filed May 23, 2011, the disclosure of which is hereby incorporated herein by reference in its entirety.

### FIELD OF THE DISCLOSURE

This disclosure is in the field of configuring software programmable identifications of slave components in a circuit.

### BACKGROUND

In most conventional serial bus standards, such as MIPI (a circuitry standards organization) RFFE (RF Front-End), several slave components can exist on the bus. Each slave has a unique Slave ID (USID). To minimize bus overhead, there are only a finite number of bits used to assign the USID. This leads to the potential of multiple slaves having the same USID, and therefore these multiple slaves having the same USID cannot be uniquely addressed.

To alleviate this problem, some standards allow a software programmable USID. This software programmable ID is generally in addition to a hard-wired default ID. Upon reset, the slave generally (although not always) reverts back to the hard-wired default ID.

In the MIPI RFFE standard, the product_id and manufacturer_id are used in the programming sequence to derive a potentially unique Slave ID for each slave. This works well if each chip has a unique Slave ID (due to a unique product_id, or a unique manufacturer_id, or a unique combination of product_id and manufacter_id).

In the case where the MIPI RFFE standard Slave ID is not unique (e.g. several identical chips on the same bus), software programming of the Slave ID (slave_ids) is not possible using conventional standards such as MIPI RFFE. A second conventional method is to use pins to tie high or low, with bond wires or the PCB (printed circuit board) tied high or low. In other words, the Slave ID is “mechanically” individually hardwired for each slave. However, this method has high costs associated with adding IO pins and placement on the PCB (printed circuit board). Additional pins also mean more ESD (electro-static discharge) hazards. Additional pins can also cause difficulties with the RF operation of the IC. Further, each pin can only increase the number of slaves by 2×. For example, for 4 slaves we need 2 pins (set at 00, 01, 10, and 11), and for 8 slaves need 3 pins (000 though 111). This hard wiring method does have the advantage of eliminating the need for the bus master to have several GPIO pins that are used as slave selects. GPIO stands for General Purpose Input/Output.

A third conventional method uses eFuses to configure slaves during production. This requires more programming (setting the eFuses) during production, and requires the customers and suppliers to inventory and track the slaves individually and uniquely as they are organized into larger circuits.

The main problem is that identical components generally cannot be easily uniquely identified in a circuit, and therefore it is difficult to use software to assign unique identifications to each of the identical components.

In other words, if you have a group of children all named Sam, how do you instruct just one of the Sams (the first Sam) that you are changing his name (and only his name) to Fred? And then, how do you instruct just one of the remaining Sams (the second Sam) that you are changing his name (and only his name) to Bill? And so forth.

### SUMMARY

The present disclosure relates to a method in which the slaves are cascaded on a bus, and cascading slave-to-slave communication is used to prioritize (or sequence) the software slave ID programming. In one embodiment, the first slave in the cascade stalls the programming of other slaves until the first slave's programming is complete. Once completed, the first slave then enables programming of the second slave, and so on. The present disclosure is compatible with (does not conflict with) the MIPI RFFE standard. This embodiment allows multiple placements of identical slaves on the bus, and still provides a method to uniquely identify and control each slave by using cascading software slave ID programming.

As a first example, a group of three children have the same name (Sam). The first Sam holds his hands over the ears of the second Sam, and the second Sam hold his hands over the ears of the third Sam, and so forth. This organization may be called a serial disablement (the first disables the second, and the second disables the third), or a cascading disablement. Only the first Sam has uncovered ears, so only the first Sam can hear commands. Parenthetically, a structure with a similar effect may be created by lack of enablement (instead of disablement), wherein initially only the first Sam is enabled, and the other Sams are initially not enabled.

Returning to the example of cascading disablement, a teacher (or master) commands, “Sam, your new name is Fred, and put your hands in your pockets.” Only the first Sam (now Fred) hears and obeys the teacher by accepting his new name (Fred) and removing his hands from the ears of the second Sam, thus removing the disablement of Sam. Alternatively, this command may be in two parts, “Sam, your new name is Fred. Fred, put your hands in your pockets.” Now the second Sam can hear future commands from the teacher. The third Sam still cannot hear commands, because his ears are still covered by the hands of the second Sam.

The teacher then says, “Sam, your new name is Bill, and put your hands in your pockets.” The first Sam (now Fred), hears and ignores the teacher because the commands are directed towards Sam. The second Sam hears and obeys. Again alternatively, this command may be in two parts, “Sam, your new name is Bill. Bill, put your hands in your pockets.”

Thus, the first Sam is now named Fred, the second Sam is now named Bill, and the third Sam can hear the next command for the next new name. In this fashion, a large number of Sams can be sequentially renamed, because only one Sam can hear the teacher at any time.

Interestingly, it is not essential to rename the last Sam, because if all of the other Sams are renamed then the last Sam is the only Sam. However, preferably the last Sam is renamed according to some sequential list of names.

Additionally, the last Sam may be “renamed” as Sam. For example the last Sam is hard-wired with a default/initial name of Sam, and he may be “renamed” as Sam in a programmable USID which is stored in a register, and which may take priority over the hard-wired default name under most circumstances.

Further, in the above example, the first child initially disabled the second child (by placing hands over the ears of the second child), and then later stopped disabling the second child (by removing the hands). This is the case of the children having a default condition of enablement, and needing a signal (hands over the ears) to be disabled.

Alternatively, the first child might initially not enable the second child, and then later actively enable the second child. In this case, the results are the same, but the exact logic is slightly technically different (stopping disablement, in contrast to granting enablement).

In one embodiment, a method for uniquely configuring a first slave having an initial USID (Unique Slave ID) comprises: providing the first slave; performing a first name change (including receiving, by the first slave, a first reference voltage having a first start up value, and receiving, by the first slave, a first new USID which is different from the initial USID); and performing a first transition (including sending, by the first slave after receiving the first new USID, a first output reference voltage having a second start up value). The first new USID is also known as a programmable USID.

Those skilled in the art will appreciate the scope of the present disclosure and realize additional aspects thereof after reading the following detailed description of the preferred embodiments in association with the accompanying drawings.

### BRIEF DESCRIPTION OF THE DRAWINGS

The accompanying drawings incorporated in and forming a part of this specification illustrate several aspects of the disclosure, and together with the description serve to explain the principles of the disclosure.

FIG. 1 illustrates a cascading configuration using VIO and VIO2 (one additional pin is required).

FIG. 2 illustrates a cascading configuration using GPI and GPO (two additional pins are required).

FIG. 3 illustrates a cascading configuration using signal pins (no additional pins are required).

FIG. 4 illustrates an alternative cascading configuration using signal pins (no additional pins are required).

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

As a preliminary matter, slaves placed on a bus are cascaded by one of several methods. Because of the cascade, only the first slave on the bus is active immediately after power up and before system configuration is complete. The first slave is programmed to have a new slave ID. Programming a new slave ID in the first slave activates a trigger to program the second slave. The second slave is programmed, which in turn triggers the third slave. This cascading/triggering process continues until all slaves are programmed with new unique (and preferably sequential) slave IDs. At this point all devices are active on the bus and can be accessed (through their new unique slave IDs) without interference with each other.

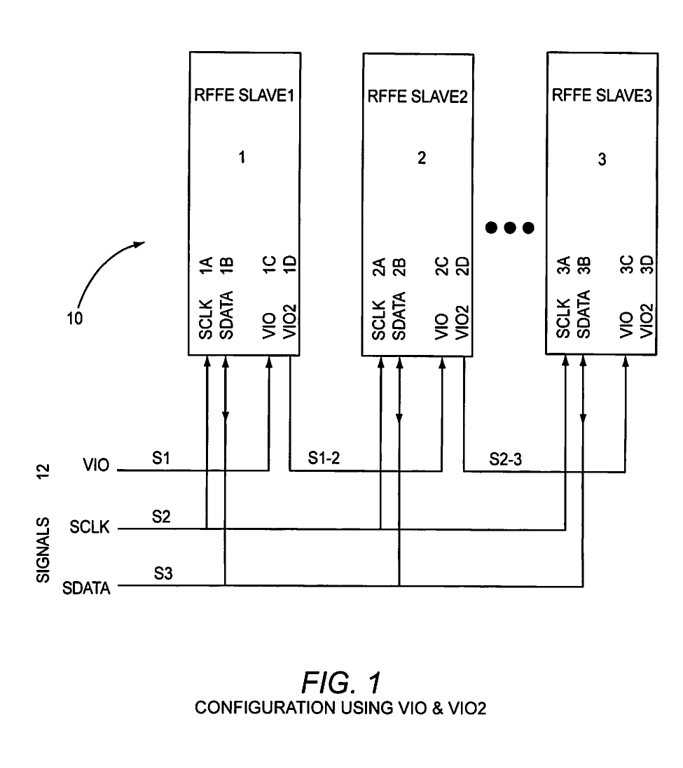

A MIPI RFFE standard slave interface has a VIO pin that can be used to put the slave into a shutdown (or sleep or reset) mode. If VIO is low (low voltage, or shut down value), the slave is in a shutdown mode. In this shutdown mode, the slave registers are in reset, which generally sets (resets) the USID (Unique Slave ID) to its hardwired “power on” default value. Since all the slaves in FIG. 1 are identical, all the slaves will have the same hardwired USID (not really “unique” at this time) serving as a default USID.

It is possible, although perhaps contrary to the present MIPI RFFE, to have a reset which retains the software USID in some of the slave registers, and thus does not reset/revert back to the hardwired USID during reset (VIO low).

In MIPI RFFE, version 1.10, Jul. 26, 2011, VIO is described as an “input/output supply/reference voltage,” and is rather complex. VIO generally only powers the level shifters in the 10 pads, whereas the rest of the slave may have power (from Vbatt, not shown) even if VIO is low. Less commonly, in some products the entire digital block is powered from VIO. However, when VIO goes low, generally the slave does not operate, but will be in a standby state and the serial interface is turned off. In the standby state, the USID does not matter.

So for either case (whether VIO powers the entire slave or just the level shifters), when VIO goes low, then the USID is a “don't care” (because the serial interface is inactive).

Thus, as discussed above, the programmable USID is stored in a register, and resetting the slave resets the registers and reverts the slave back to the hard wired USID. With respect to MIPI RFFE, the embodiment of FIG. 1 requires one additional pin (VIO2), as discussed immediately below.

FIG. 1 illustrates a first embodiment having cascading configuration using VIO and VIO2 (one additional pin is required). Specifically, FIG. 1 has three input signals 12 including: shutdown/reset signal VIO S1, clock signal SCLK S2, and data signal SDATA S3. The data signal S3 may be bi-directional, as illustrated by the arrows on the signal line.

FIG. 1 also has a cascading set of slaves 10, including slave 1, slave 2 and slave 3. Slave 1 has three input pins: pin 1A for a clock signal S2; pin 1B for a data signal S3; and pin 1C for a shutdown/reset signal S1. Slave 1 has one output pin, pin 1D for an output cascading shutdown/reset signal S1-2. Output pin 3D on the final slave (slave 3) is not used, is superfluous, but is present when the slaves are identical. Thus, the slaves of FIG. 1 each require only a single additional output pin (pin 1D or pin 2D or pin 3D) to allow cascade software programming, as discussed in the Sam example above.

The VIO2 output pin 1D of the first slave (slave 1) is connected to input VIO pin 2C of the second slave (slave 2) through signal S1-2, and the output pin 2D of the second slave is connected to input VIO pin 3C of the third slave (slave 3) through signal S2-3.

This figure may be expanded by inserting additional slaves between slave 2 and slave 3, as indicated by the ellipsis in FIG. 1.

Initially, VIO signal S1 is low, which sets (resets) the USID (Unique Slave ID) of slave 1 to its “power on” hardwired default value. For example, the default value may be 15 (or 1111 in binary). Also, initially VIO2 output pin 1D of slave 1 is low, and is connected to VIO input pin 2C of slave 2 such that slave 2 similarly sets (resets) the USID (Unique Slave ID) of slave B to its “power on” default value. In this fashion, the VIO input of every slave is low initially.

Introducing some convenient terminology, the first slave (slave 1) has a first reset input (VIO signal S1) connected to a first reset input pin 1C, and a first reset output (VIO2 signal S1-2) which is connected to the VIO input pin 2C of the second slave (slave 2).

Referring to FIG. 1, and assuming the slaves all start with a hardwired USID of 15 (or 1111 in binary), an example of the renaming procedure follows:
As an initialization, the master provides a VIO low signal S1 (a first reference voltage having a reset value) which disables (or resets) slave 1. Similarly, slave 1 outputs a VIO low signal S1-2 which resets slave 2.
As a first name change, a master raises VIO signal S1 (providing a first reference voltage having a start up value). This enables slave 1. All other slaves are still in reset because slave 1 continues to output a VIO low signal S1-2 which continues to reset slave 2, and slave 2 similarly continues to reset slave 3.
Also as part of the first name change, the master performs a programming command addressed to USID=14 (using product_id[7:0], manufacturer_id[9:0], USID=15, which is the initial hardwired default USID for all of the slaves) to program slave 1's USID to 14 (hardwired USID minus 1). Brackets indicate bit positions. As previously discussed, slaves 2 and 3 do not hear this programming command. In the MIPI RFFE specification, a programming sequence is used to change the USID. This is a multi-step process that requires prior knowledge of the Slave's product_id[7:0] and manufacturer_id[9:0]. If the incorrect product_id or manufacturer_id is used, the Slave will abort the programming sequence. The steps are:
   1) Write address 29 with the correct product_id[7:0].
   2) Write address 30 with the correct manufacturer_id[7:0].
   3) Write address 31 with the correct manufacturer_id[9:8] and new (arbitrary) USID.
In general, each manufacturer has a unique manufacturer_id. Each product will have a unique product_id. The patent solves the problem of several identical slaves (same product_id and manufacturer_id) on the same bus.
As a first transition, at the conclusion of programming slave 1's USID to 14, the slave 1's VIO2 output pin 1D is changed from low to high, thus enabling (or starting up) slave 2 through signal S1-2.
As a second name change, the master uses USID=15 to program a new USID to slave 2 (initially having a hardwired USID of 15). Slave 1 ignores the programming commands because its USID is now 14. Slave 2 is programmed to 13. At the conclusion of programming, Slave 2 enables its VIO2 output pin 2D to high, and output signal S2-3 is high.
Repeat until all slaves are programmed with unique USIDs.

It is not essential to rename the last slave, because it is acceptable for the last slave to be the only slave with the initial USID. However, it is preferable to rename the last slave for the sake of symmetry (for example, renaming the slaves in a sequential decreasing order), and in order to place a name in the registers of the last slave.

Further, note that this cascade method is limited by the number of bits in the USID. For example, in the case of 4 bits, the slaves may be renamed from 14 down to 1 (for 14 slaves in MIPI RFFE, because 0 is reserved for other purposes), and a fifteenth slave (last slave) may optionally be “renamed” in its registers as 15 (the same as its hardwired default name in this example). The renaming may occur sequentially, or may occur randomly (but without repetition). The last or final slave does not have to be renamed, because its initial name becomes unique after all previous slaves have been renamed.

Preferably, the first slave sends a signal to the master confirming that its name has been changed, and then, after receiving this confirmation, the master names the second slave. Alternatively, the master may wait a safe period of time (perhaps double the expected period of time that it should take for the first slave to change its name and to send the VIO2 high signal to the second slave), and then assume that the first name change was successful, and then name the second slave. The VIO2 output pin 3D of the last slave is not used for cascading renaming purposes, but may be used to signal to a master (not shown) that the renaming of all of the slaves has been completed.

After all of the names are changed, changes in the VIO signal S1 should quickly propagate (be re-sent) from slave 1 to slave 2, and so on downstream, so that all slaves effectively receive the VIO signal S1 at almost the same time. In theory, a very long chain (perhaps 516 slaves) may have timing problems (in ordinary operations after the renaming is completed) due to delays in passing/repeating the VIO signal from slave to slave. This should not be a problem in small chains such as 16 slaves. Further, generally devices are programmed when the VIO stays high (enabled). At the end of a burst or phone call, VIO will go low. Thus, the above discussed propagation delays are generally not critical.

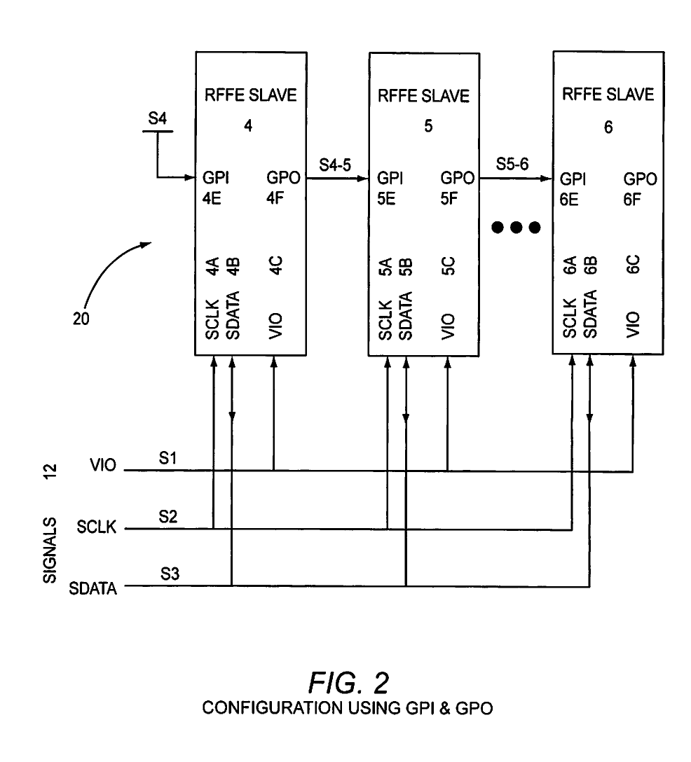

FIG. 2 illustrates a cascading configuration of slaves 20 using GPI and GPO (two additional pins are required). This method requires two extra pins (GPI 4E and GPO 4F in slave 4), relative to MIPI RFFE. GPI is a slave enablement pin (distinct from VIO), and GPO is an output pin (similar in function to VIO2 of FIG. 1).

This embodiment avoids the timing difficulties discussed above in FIG. 1 with respect to propagating the VIO signal in long chains. This embodiment also allows enablement or disablement logic which may be different from that of the VIO.

The slaves (slave 4, slave 5, and slave 6) use GPO output pins (4F, 5F, and 6F respectively) to stall the programming of downstream slaves. The first slave has the GPI 4E tied high to enable it. Thus, slave 1 is always enabled with respect to GPI.

Initially, slave 1 holds its output GPO low to disable slave 2 via signal S4-5. Similarly, slave 2 initially holds its GPO output low to disable the downstream slave via signal S5-6. The GPO output pin 6F of the last slave (slave 6 in FIG. 2) does not serve a cascading renaming function. However, this last output pin 6F may serve as feedback to a master (not shown) indicating when the renaming of all of the slaves is complete.

The programming procedure for FIG. 2 is very similar to FIG. 1, except that the GPI and GPO are used instead of the VIO and VIO2. In this fashion, the configuration of FIG. 2 can avoid the complexities (and possible problems) of FIG. 1 which may be caused by using the VIO inputs for additional (and unintended) purposes, and also can avoid potential complications.

Additionally, the configuration of FIG. 2 is more robust that FIG. 1, because in FIG. 1 the failure of a single slave may stop the essential repeating of the VIO signal to downstream slaves. In contrast, the FIG. 2 slaves all receive the VIO signal directly.

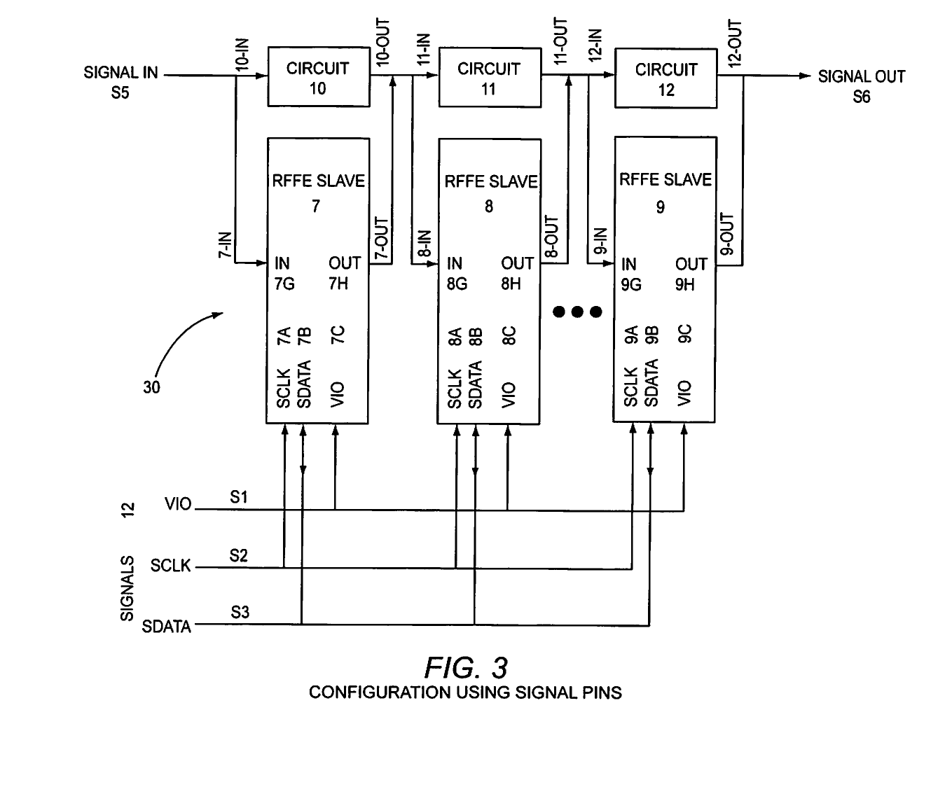

FIG. 3 illustrates a cascading slave configuration 30 using signal pins (IN and OUT). Specifically, slave 7, slave 8 and slave 9 each have an input signal pin IN and an output signal pin OUT. In slave 7, for example, the IN pin and the OUT pin may be designed for analog (AC) signals, or may be designed for digital signals. This method requires no additional pins.

These signal pins may be used to signal and control downstream slaves, similar to the control mechanisms of FIGS. 1 and 2.

In cases where identical slaves appear on the same bus, these slaves may perform the same function. For instance, adding more slaves can increase the order of a filter. In this case, the slaves may use AC pins that are multiplexed until configuration of the slaves is complete.

The VIO signal S1, SCLK signal S2, SDATA signal S3, and the associated slave input pins are the same as in FIG. 1 and FIG. 2. Referring to FIG. 3, slave 7 is in parallel with circuit 10, and slave 8 is in parallel with circuit 11, and slave 9 is in parallel with circuit 12.

A signal S5 branches at a node and inputs to slave 7 as signal 7-IN, and inputs into associated parallel circuit 10 as 10-IN. The output signal of slave 7 is 7-OUT. During renaming, the parallel circuits 10, 11, and 12 are inactive, and FIG. 3 operates similar to FIG. 2 with respect to renaming logic.

In FIG. 3, circuits 10, 11, and 12 may be AC coupled circuits (meaning that these circuits do not pass DC signal or control signals used for programming the USID). However, these circuits do pass or operate upon the AC signals present at SIGNAL IN S5 and passing to SIGNAL OUT S6. In this case, the AC signals present at S5 and S6 are the desired input and output signals that the system 30 operates upon.

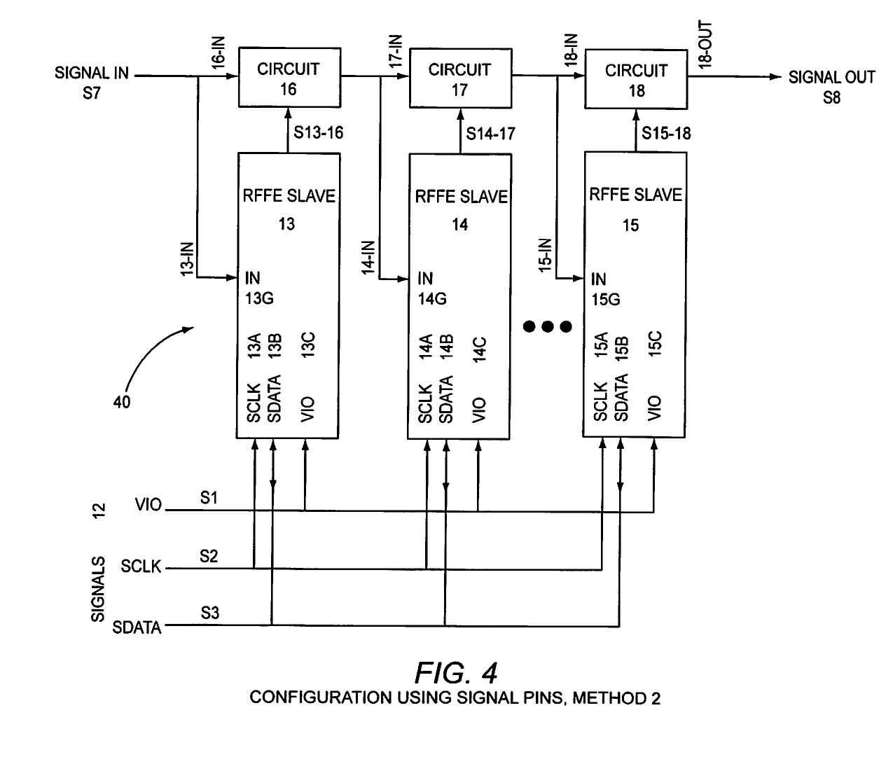

FIG. 4 illustrates an alternative cascading slave configuration 40 using signal pins (IN and OUT). Broadly, FIG. 4 illustrates a set of slaves 13, 14, and 15 with associated circuits 16, 17, and 18 respectively. The standard signals (S1, S2, and S3) and standard signal input pins (13A, 13B, and 13C for slave 13) are discussed in detail above regarding FIG. 1.

In contrast to FIG. 3, FIG. 4 does not directly control the enablement/disablement signal path to the next slave. Instead, in FIG. 4 the output of slave 13 (signal S13-16) directly controls an associated circuit 16, which, in turn, controls the next slave.

For example, slave 13 may control an associated circuit 16 to enable it, such as with an existing enablement pin in circuit 16. If an enablement pin in circuit 16 is disabled, then downstream slave 14 is stalled (disabled) from receiving an RFFE renaming command from a master (not shown). After being renamed, then slave 1 enables associated circuit 16 to enable Slave 2.

In the following claims, the term “reset” is defined broadly as placing a slave into a state where it cannot receive a new USID, and the term “start up” is defined broadly as placing the slave in a state where it can receive a new USID. In other words, reset is defined broadly as comprising at least one of the following functions: sleep, off, disabled, not enabled, and shut down. Similarly, the term “start up” is defined broadly as comprising at least one of the following functions: start up, enabled, not disabled, and active.

Those skilled in the art will recognize improvements and modifications to the preferred embodiments of the present disclosure. All such improvements and modifications are considered within the scope of the concepts disclosed herein and the claims that follow.

What is claimed is:

1. A method for uniquely configuring a first slave having an initial USID (Unique Slave ID), the method comprising:
providing the first slave,
performing a first name change comprising:
receiving, by the first slave, a first input reference voltage having a first start up value,
receiving, by the first slave, a first new USID which is different from the initial USID; and
performing a first transition comprising:
sending, by the first slave after receiving the first new USID, a first output reference voltage having a second start up value.

2. The method of claim 1, further comprising:
performing an initialization before performing the first name change, wherein performing the initialization comprises:
receiving, by the first slave, a second input reference voltage having a first reset value, and
sending, by the first slave, a second output reference voltage having a second reset value.

3. The method of claim 2, wherein performing the first name change further comprises:
continuing to send, from the first slave, the second output reference voltage having the second reset value.

4. The method of claim 2, further comprising:
providing a second slave;
receiving, by the second slave, the second output reference voltage having the second reset value;
receiving, by the second slave, the first output reference voltage having the second start up value; and
receiving, by the second slave, a second new USID which is different from the first initial USID and is different from the first new USID.

5. The method of claim 1, wherein performing the first name change further requires saving, by the first slave, the first new USID.

6. The method of claim 5, wherein the first slave saves the first new USID as at least part of a new first slave name.

7. The method of claim 1, further comprising:
providing a last slave, and
wherein the last slave retains the initial USID as at least part of a last slave name, and
wherein all other slaves that are associated with the last slave each receive a new unique USID.

8. A method for uniquely configuring an intermediate slave having an initial USID (Unique Slave ID), the method comprising:
providing the intermediate slave, wherein the intermediate slave is associated with a previous slave and is associated with a next slave;
performing an intermediate slave initialization comprising:
receiving, by the intermediate slave, an intermediate input reference voltage having an intermediate reset value,
performing an intermediate name change comprising:
receiving, by the intermediate slave, an intermediate reference voltage having a first intermediate start up value,
receiving, by the intermediate slave, an intermediate new USID which is different from the initial USID and is different from all previous new USIDs during a slave naming process; and
performing a first transition comprising:
sending, by the intermediate slave after receiving the intermediate new USID, an intermediate output reference voltage having a second intermediate start up value.

9. A method for uniquely configuring a first slave having an initial USID (Unique Slave ID) and a second slave having the same initial USID, the method comprising:
providing the first slave and the second slave, wherein the first slave has a first reset input and a first reset output, and wherein the second slave has a second reset input connected to the first reset output of the first slave;
performing an initialization comprising:
receiving, at the first reset input of the first slave, a first reference voltage having a first reset value, and
sending, from the first reset output of the first slave to the second reset input of the second slave, a first output reference voltage having a second reset value;
performing a first name change comprising:
receiving, at the first reset input of the first slave, a first reference voltage having a first start up value,
continuing to send, from the first reset output of the first slave to the second reset input of the second slave, the first output reference voltage having the second reset value, and
receiving, by the first slave, a first new USID which is different from the initial USID;
performing a first transition comprising:
sending, by the first slave after receiving the first new USID, a second output reference voltage having a second start up value from the first reset output of the first slave; and
performing a second name change comprising:
receiving, by the second slave at the second reset input, the second output reference voltage having the second start up value, and
receiving, by the second slave, a second new USID which is different from the initial USID and is different from the first new USID.

10. The method of claim 9, further comprising:
providing a third slave having the same initial USID, and having a third reset input connected to a second reset output of the second slave;
performing a second transition comprising:
sending, by the second slave after receiving the second new USID, a third output reference voltage having a third start up value from the second reset output; and
performing a third name change comprising:
receiving, by the third slave at the third reset input, the third output reference voltage having the third start up value, and
receiving, by the third slave, a third new USID which is different from the initial USID, is different from the first new USID, and is different from the second new USID.

11. The method of claim 9, wherein the first and second slaves are configured to conform with MIPI Alliance Specification for RF Front-End Control Interface version 1.10, wherein the first reset input is an active low reset, and the second reset input is an active low reset.

12. The method of claim 9, wherein the first new USID has a value of one less than the initial USID, and wherein the second new USID has a value of two less than the initial USID.

13. The method of claim 9, wherein the first new USID has a value of one more than the initial USID, and wherein the second new USID has a value of two more than the initial USID.

14. The method of claim 9, wherein performing the first name change further comprises:
storing the first new USID in one or more registers of the first slave.

15. The method of claim 9, wherein performing the initialization, the first name change, the first transition, and the second name change is controlled by a master.

16. The method of claim 9, wherein performing the first name change further comprises:
receiving, by the first slave, a first new name command directed to the initial USID;
receiving, by the first slave, the first new USID; and
storing, by the first slave, the first new USID in a first slave register.

17. The method of claim 16, wherein performing the second name change further comprises:
receiving, by the second slave, a second new name command directed to the initial USID;
receiving, by the second slave, the second new USID; and
storing, by the second slave, the second new USID in a second slave register.

18. The method of claim 17, wherein performing the second name change further comprises:
ignoring, by the first slave, the second new name command directed to the initial USID.

19. The method of claim 9, wherein performing the first name change further comprises:
sending, by the first slave, a communication indicating that the first slave has received the first new USID.

20. The method of claim 9, further comprising:
sending a termination signal, by a last slave, indicating that all of the slaves have stored distinct new USIDs in their respective registers.

21. A method for uniquely configuring a first slave having an initial USID (Unique Slave ID) and a second slave having the same initial USID, the method comprising:
providing the first slave and the second slave, wherein:
the first slave has a first enablement input pin and a first enablement output pin,
the first enablement input pin is tied to a fixed enabling voltage,
the second slave has a second enablement input pin connected to the first enablement output pin of the first slave;
performing an initialization comprising:
receiving, at the first enablement input pin of the first slave, the fixed enabling voltage
sending, from the first enablement output pin of the first slave to the second enablement input pin of the second slave, a first enablement output signal having a first disabling voltage;
performing a first name change comprising:
receiving, by the first slave, a first command directed to the initial USID and providing a first new USID which is different from the initial USID;
performing a first transition comprising:
sending, by the first slave after receiving the first new USID, the first enablement signal output having a first enabling voltage; and
performing a second name change comprising:
receiving, by the second enablement input of the second slave, the first enablement signal output having the first enabling voltage; and
receiving, by the second slave, a second command directed to the initial USID and providing a second new USID which is different from the initial USID, and which is different from the first new USID.

22. A cascading method for uniquely configuring a first slave having an initial USID (Unique Slave ID) and a second slave having the same initial USID, the method comprising:
providing the first slave with a first new USID while keeping the second slave shut down, wherein the first new USID is different from the initial USID;
starting up the second slave; and
providing the second slave with a second new USID, wherein the second new USID is different from the first new USID.

23. The method of claim 22, wherein:
the initial USID is hardwired into the first slave;
the initial USID is hardwired into the second slave;
the first new USID is stored in a register of the first slave; and
the second new USID is stored in a register of the second slave.

24. The method of claim 22, wherein:
the first slave has a reference voltage input;
the first slave is configured to reset when a reference voltage signal has a reset value, and to start up when the reference voltage signal has a start up value;
the first slave includes a reference voltage output connected to the reference voltage input of the second slave;
the first slave is configured to initially send a reset signal to the second slave;
the first slave is configured to, after being renamed, send a start up signal to the second slave.

25. The method of claim 22, wherein:
providing the first slave with the first new USID further comprises storing, by the first slave, the first new USID in a first slave register; and

26. The method of claim 22, wherein:
providing the second slave with the second new USID further comprises ignoring, by the first slave, any command directed towards any slave operating under the initial USID.

27. A first slave comprising:
a reference voltage receiving portion; and
a reference voltage outputting portion,
wherein the first slave is configured to perform the following steps:
perform a first name change comprising:
receiving, by the first slave, a first input reference voltage having a first start up value,
receiving, by the first slave, a first new USID which is different from the initial USID; and
perform a first transition comprising:
sending, by the first slave after receiving the first new USID, a first output reference voltage having a second start up value.
